(19) United States
(12) Patent Application Publication
(10) Pub. No.: US 2005/0036465 A1
(43) Pub. Date: Feb. 17, 2005

(54) Device, system and method of signal detection for wireless network

(76) Inventors: Shai Waxman, Haifa (IL); Yuval Bachrach, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/608,079

(22) Filed: Jun. 30, 2003

(51) Int. Cl. H04Q 7/24

(52) U.S. Cl. 370/338

(57) ABSTRACT

Briefly, a device, system and method of signal detection for wireless network. A method in accordance with an exemplary embodiment of the invention may include, for example, engaging a first signal from a first access point/station, and, during engagement, searching and/or detecting and/or engaging a second signal transmitted by a second access point/station.

### BACKGROUND OF THE INVENTION

In the field of wireless communication, a Wireless Local Area Network (WLAN) may include a station able to receive a first signal transmitted by a first access point. A co-channel interference may occur, for example, when a second access point transmits a second signal, which may interfere with the first signal. The co-channel interference may result in various errors and/or problems, for example, decrease in effective WLAN throughput, or engagement of a weak signal, which may be subsequently lost, instead of engagement of a desired stronger signal.

Problems and errors associated with co-channel interference may be partially mitigated using a filter to filter-out co-channel interference based on comparison of the co-channel interference to a pre-defined threshold value. However, such filtering may result in undesired effects, for example, filtering-out weak WLAN signals regardless of co-channel interference may prevent engagement of desired weak transmissions by a remote user.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic illustration of a wireless communication station in accordance with exemplary embodiments of the invention;

FIG. 2 is a schematic illustration of a WLAN system in accordance with exemplary embodiments of the invention;

FIG. 3 is a schematic illustration of an exemplary operation scenario of the WLAN system of FIG. 2;

FIG. 4 is a schematic illustration of a transmission/reception time-slot diagram demonstrating the operation of a conventional WLAN station in an exemplary scenario;

FIG. 5 is a schematic illustration of a transmission/reception time-slot diagram demonstrating the operation of a WLAN station in accordance with an embodiment of the invention in the exemplary scenario of FIG. 4; and

FIG. 6 is a flow chart diagram of a method of signal detection in accordance with exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It should be understood that embodiments of the invention may be used in a variety of applications. Although the invention is not limited in this respect, embodiments of the invention may be used in many apparatuses, for example, a modem, a personal computer, a desktop computer, a mobile computer, a laptop computer, a notebook computer, a Personal Digital Assistant (PDA) device, a tablet computer, a server computer, a network, a Local Area Network (LAN), a Wireless LAN (WLAN), a modem, a wireless modem, a wireless communication device, devices and/or networks operating in accordance with the existing 802.11a, 802.11b, 802.11g, 802.11n and/or future versions of the above standards, a Personal Area Network (PAN), Wireless PAN (WPAN), units and/or devices which are part of the above WLAN and/or PAN and/or WPAN networks, one way and/or two-way radio communication systems, and the like.

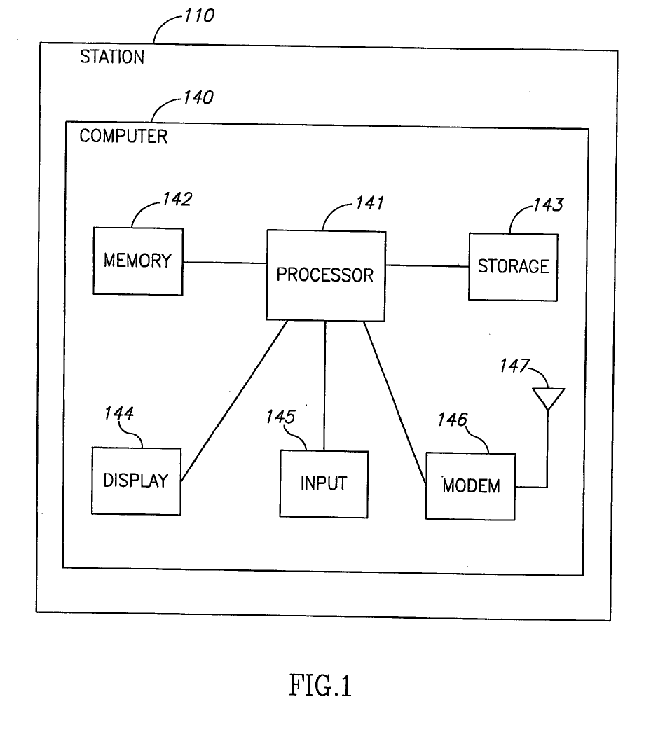

FIG. 1 schematically illustrates a station 110 in accordance with exemplary embodiments of the invention. Station 110 may operate using a signal detection method in accordance with embodiments of the invention, as described in detail below.

In some embodiments, station 110 may include a personal computer, a desktop computer, a mobile computer, a laptop computer, a notebook computer, a Personal Digital Assistant (PDA) device, a tablet computer, a network device, a network, a internal and/or external modem and/or fax-modem device and/or card, a peripheral device, a WLAN device, or the like.

In the exemplary embodiment of FIG. 1, station 110 may include a computer 140, which may include a processor 141, a memory unit 142, a storage unit 143, a display unit 144, an input unit 145, a WLAN modem 146, and an antenna 147.

Processor 141 may include, for example, a Central Processing Unit (CPU), a Digital Signal Processor (DSP), or any suitable specific and/or general and/or multi-purpose processor or micro-processor.

Memory 142 may include, for example, a Random Access Memory (RAM). Storage unit 143 may include, for example, a hard disk drive. Display unit 144 may include, for example, a monitor. Input unit 145 may include, for example, a keyboard, a mouse, or a touch-pad.

Modem 146 may include, for example, a modem able to operate in accordance with one or more of the existing 802.11a standard, 802.11b standard, 802.11g standard, 802.11n standard and/or future versions of these standards, and/or any other suitable existing and/or future standard. Antenna 147 may include an internal and/or external Radio Frequency (RF) antenna, for example, a dipole antenna. In some embodiments, antenna 147 may be integral to modem 146 and/or integrated within modem 146. It is noted that in some embodiments, modem 146 may include a detector unit to detect properties of the signals received by station 110. In accordance with embodiments of the invention, such detection may be performed by other suitable components of station 110 and/or computer 140, for example, processor 141 and/or software applications, drivers and/or operating systems associated with station 110 and/or computer 140.

It is noted that station 110 and/or computer 140 may include various other components, and/or may be configured with additional and/or alternative units. Further, station 110 and/or computer 140 may be implemented using any suitable combination of hardware and/or software, and may include any circuit, circuitry, unit or combination of integrated and/or separate units or circuits, as are known in the art, to perform desired functionalities. It is noted that the terms “circuit” and “circuitry” as used herein, may include any suitable combination of hardware components and/or software components. For example, station 110 may include detection circuitry, analysis circuitry, selection circuitry, comparison circuitry, processing circuitry, reception circuitry, engagement circuitry, reset circuitry, storage circuitry, one or more analyzer units, comparison units, decision units, processing units, storage units, detection units, buffers, memories, and various other types of units, components and/or circuitry, which may be used to perform methods and/or operations as discussed below in accordance with exemplary embodiments of the invention, and which may be implemented using any suitable combination of hardware components and/or software components (including, for example, applications, drivers, and/or operating systems) of station 110.

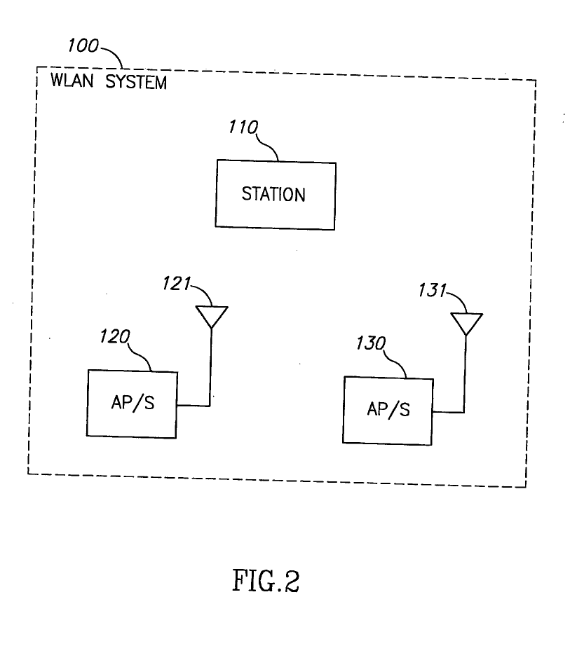

FIG. 2 schematically illustrates a WLAN system 100 in accordance with exemplary embodiments of the invention. System 100 may include a station 110, an Access Point/Station (AP/S) 120 and, optionally, and an additional AP/S 130. In some embodiments, system 100 may further include one or more stations similar to station 110, and/or one or more additional access points/stations similar to AP/S 130.

AP/S 120 may include one of two alternate circuits. In an exemplary embodiment, AP/S 120 may include any suitable WLAN access point circuitry, for example, access point circuitry able to operate in accordance with one or more of the existing 802.11a standard, 802.11b standard, 802.11g standard, 802.11n standard and/or future versions of these standards, or any other suitable existing or future standard. In an alternate embodiment, AP/S 120 may include any suitable wireless communication station, device, circuitry or functionality, for example, a wireless communication station similar to station 110. Optionally, AP/S 120 may include an antenna 121. Antenna 121 may include an internal and/or external Radio Frequency (RF) antenna, for example, a dipole antenna. In some embodiments, antenna 121 may be integral to the circuitry of AP/S 120 and/or otherwise integrated within AP/S 120.

AP/S 130 may include one of two alternate circuits. In an exemplary embodiment, AP/S 130 may include any suitable WLAN access point circuitry, for example, access point circuitry able to operate in accordance with one or more of the existing 802.11a standard, 802.11b standard, 802.11g standard, 802.11n standard and/or future versions of these standards or any other suitable existing or future standard. In an alternate embodiment, AP/S 130 may include any suitable wireless communication station, device, circuitry or functionality, for example, a wireless communication station similar to station 110. Optionally, AP/S 130 may include an antenna 131. Antenna 131 may include an internal and/or external Radio Frequency (RF) antenna, for example, a dipole antenna. In some embodiments, antenna 131 may be integral to the circuitry of AP/S 130 and/or otherwise integrated within AP/S 130.

It will be appreciated that the term “signal” as used herein may include, for example, a signal, a packet, a frame, a data structure, a preamble, a header, a content and/or a data, which may be transmitted and/or received in accordance with various formats and/or standards.

It will be appreciated that, although the scope of the invention is not limited in this respect, the term “receive”, and its derivative terms, e.g., “receiving” and “reception”, as used herein, may include, for example, physically receiving a signal using an antenna and/or receiver and/or transceiver and/or modem, physically receiving a wireless communication transmission, receiving energy indicating a wireless communication transmission, and/or physically receiving a signal over a wireless communication link and/or network and/or WLAN.

It will be appreciated that, although the scope of the invention is not limited in this respect, the term “engage”, and its derivative terms, e.g., “engaging” and “engagement”, as used herein, may include handling and/or performing operations on a received signal, for example, processing a signal, processing a content of a signal, performing operations in relation to a signal, and/or performing operations based on a content of a signal.

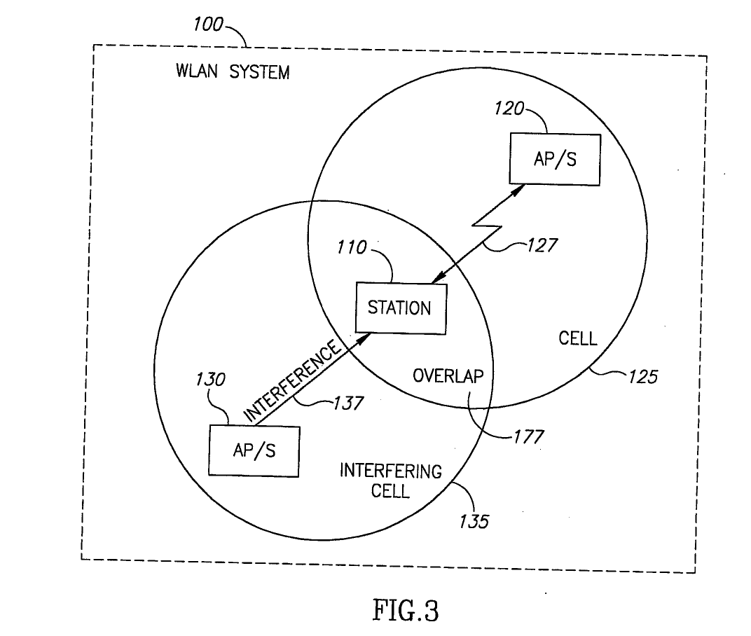

FIG. 3 schematically illustrates an exemplary operation scenario of system 100 in accordance with embodiments of the invention. In this scenario, a first cell 125 may include, for example, the geographic area covered by AP/S 120 and a second cell 135 may include, for example, the geographic area covered by AP/S 130. In the exemplary scenario of FIG. 3, cell 125 and cell 135 may at least partly overlap, for example, within overlap area 177. Furthermore, in the exemplary scenario of FIG. 3, station 110 may be located within overlap area 177 of cells 125 and 135. It is noted that in some embodiments, a plurality of cells similar to cells 125 and 135 may exist and/or overlap.

In some embodiments, AP/S 130 may transmit a signal 137; station 110 may receive signal 137 from AP/S 130 and may engage signal 137. During such engagement of signal 137 by station 110, AP/S 120 may transmit a signal 127. In some embodiments, during engagement of signal 137 from AP/S 130, station 110 may detect signal 127 from AP/S 120. In some embodiments, upon such detection, station 110 may stop engagement of signal 137 from AP/S 130, and may start engagement of signal 127 from AP/S 120.

In some embodiments, during engagement of signal 137, station 110 may continuously, repeatedly and/or substantially continuously, search for additional signals, for example, signal 127. In some embodiments, such search may include, for example, receiving and/or analyzing and/or engaging and/or partially engaging signals other than signal 137. In some embodiments, such analysis may include, for example, detecting data carried by signal 127, for example, a preamble or header data, which may indicate a beginning or a part of signal 127.

In some embodiments, during engagement of signal 137 and upon detection of signal 127, station 110 may either continue to engage signal 137, or, alternatively, stop engaging signal 137 and start engaging signal 127. In some embodiments, station 110 may select between these alternatives using pre-defined criteria.

In some embodiments, the criteria may include detecting the strength of signal 127, detecting the strength of signal 137, and selecting to continue, start or re-start engaging the signal with the higher strength, as further explained below. Additionally or alternatively, the criteria may include detecting the relative strength of signal 127 in comparison to signal 137, or vice versa, and selecting to continue, start or re-start engaging the signal with the relatively higher strength, as further explained below.

Additionally or alternatively, the criteria may include detecting the quality of signal 127, detecting the quality of signal 137, and selecting to continue, start or re-start engaging the signal with the higher quality, as further explained below. Additionally or alternatively, the criteria may include detecting the relative quality of signal 127 in comparison to signal 137, or vice versa, and selecting to continue, start or re-start engaging the signal with the relatively higher quality, as further explained below.

Additionally or alternatively, the criteria may include detecting the Signal-to-Noise Ratio (SNR) value of signal 127, detecting the SNR value of signal 137, and selecting to continue, start or re-start engaging the signal with the higher SNR value, as further explained below. Additionally or alternatively, the criteria may include comparing the SNR of signal 127 with the SNR of signal 137, or vice versa, and selecting to continue, start or re-start engaging the signal with the relatively higher SNR, as further explained below.

In some embodiments, station 110 or one or more of its components may perform the operations of comparison and/or analysis described above. For example, in some embodiments, these operations may be performed by computer 140, by processor 141, by modem 146, and/or by other suitable components such as, for example, a dedicated and/or multi-purpose controller and/or processor. In some embodiments, these operations may be performed using any suitable combination of hardware and/or software.

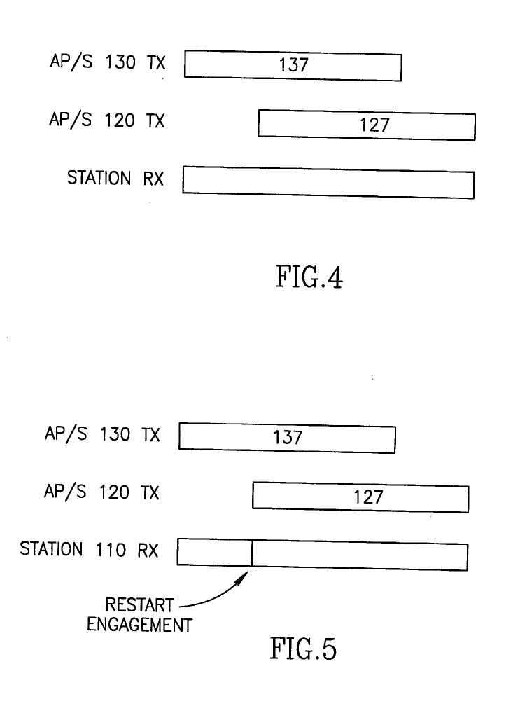

FIGS. 4 and 5 schematically illustrate transmission/reception time-slot diagrams demonstrating the operation of a conventional station (FIG. 4) and of station 110 in accordance with an exemplary embodiment of the invention (FIG. 5), respectively, in an exemplary scenario.

FIG. 4 schematically illustrates the operation of a conventional station. The conventional station may engage signal 137 from AP/S 130. During such engagement, AP/S 120 may transmit signal 127. Upon receiving signal 127, the conventional station may, for example, ignore signal 127 even though it may be stronger and/or of higher quality than signal 137.

FIG. 5 schematically illustrates the operation of station 110 in accordance with an exemplary embodiment of the invention. Station 110 may engage signal 137 from AP/S 130. During such engagement, AP/S 120 may transmit signal 127. In some embodiments, station 110 may periodically detect received signals, as explained below. Upon detecting signal 127, station 100 may compare the strength and/or quality of signal 127 and signal 127. In the event that signal 127 has a higher strength and/or quality than signal 137, for example, according to the criteria described above, station 110 may stop engaging signal 137 and, instead, may start engaging signal 127.

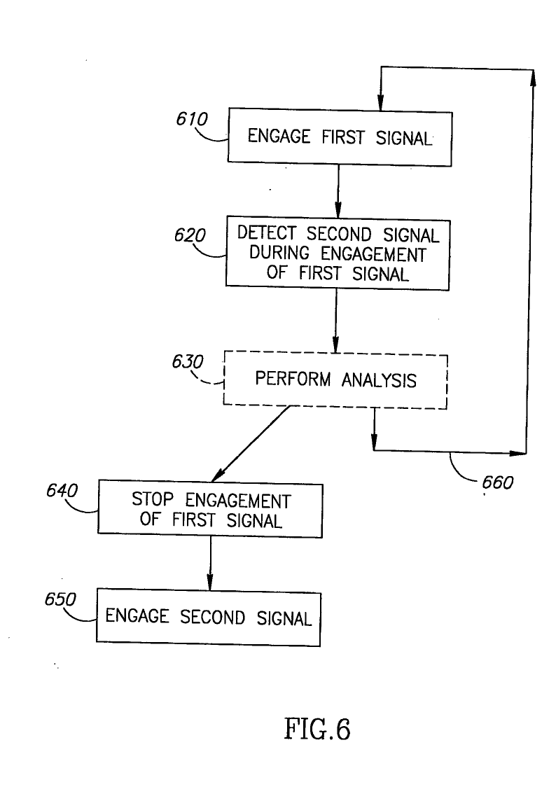

FIG. 6 is a flow chart diagram of a method of signal detection and selection in accordance with exemplary embodiments of the invention. As indicated in block 610, a first signal may be engaged. As indicated at block 620, during engagement of the first signal, a search may be performed to detect a second signal.

Optionally, as indicated at block 630, upon detecting a second signal, an analysis of the second signal may be performed. In some embodiments, such analysis may include, for example, detecting the strength, relative strength, quality, relative quality, reliability, relative reliability, SNR value, relative SNR and/or any other relevant property of the first signal and/or the second signal, as described above. Additionally or alternatively, the analysis may include, for example, comparing a property of the first signal to a corresponding property of the second signal, comparing a property of the first signal to a pre-defined threshold value, and/or comparing a property of the second signal to a pre-defined threshold value. In some embodiments, a plurality of comparison operations may be performed. In an exemplary embodiment, the analysis and/or comparison may be performed, for example, by one or more suitable components of station 110 and/or computer 140, for example, modem 146 and/or processor 141 and/or software applications, drivers and/or operating systems associated with station 110 and/or computer 140.

It is noted that in some embodiments, the operations indicated at block 630 may be optional and/or may be skipped. For example, in some embodiments, it may be pre-determined that the detection of the second signal during the engagement of the first signal is a sufficient event to stop engaging the first signal and to start engaging the second signal.

In accordance with exemplary embodiments of the above analysis, one of several alternative actions may be taken. According to a first alternative, as indicated at block 640, engagement of the first signal may be stopped, and, as indicated at block 650, engagement of the second signal may be commenced, resumed, started and/or re-started. For example, in some embodiments, engagement of the second signal may be reset and/or re-started such that some or all previous signals and/or data may be deleted, discarded, and/or otherwise abandoned. In some embodiments, an engagement buffer may be reset and/or emptied, and engagement may be reset, started and/or re-started.

It is noted that upon re-start of the engagement of the second signal, the method of FIG. 6 may be applied to the second signal, such that the second signal is now a first signal being engaged, and further signal detection may be performed.

Alternatively, as indicated by arrow 660 in FIG. 6, the second signal may be ignored and the engagement of the first signal may resume. For example, in some embodiments, if the second signal is weaker or has lower quality in comparison to the strength and/or quality of the first signal, then the second signal may be ignored, i.e., not engaged and/or not processed, and the engagement of the first signal may resume without interruption.

It will be appreciated that in some exemplary embodiments, the engagement of the first signal is not “paused”, stopped, or otherwise interrupted during detection and/or search for the second signal. Furthermore, in some embodiments, upon detection of a second signal, the engagement of the first signal may either proceed un-interrupted and un-paused, or, alternatively, be abandoned and/or discarded for engagement of the second signal.

It is noted that in some embodiments, the above operations may be repeated continuously or substantially continuously. For example, in some embodiments, detection of a second signal and/or detection of a preamble of a second signal may be performed during engagement of a first signal, or substantially continuously and/or substantially at all times. It will be appreciated that in some embodiments, detection of the second signal may be performed in parallel with the engagement of the first signal.

Although the invention is in no way limited in this regard, it is noted that various benefits may be achieved using some exemplary embodiments of the invention. For example, in some embodiments, WLAN co-channel interference, WLAN adjacent-cell interference, and problems and/or errors associated with such interferences, may be avoided and/or mitigated. In some embodiments, this may be achieved, for example, by detecting and/or engaging stronger WLAN signals during co-channel interference reception.

Additionally or alternatively, using some exemplary embodiments of the invention, a weak or a relatively weak WLAN signal may be detected and/or engaged, including, for example, from a remote and/or a relatively remote access point or station. This is in contrast, for example, to some conventional stations, which often filter-out and/or drop a weak WLAN signal and/or a signal transmitted by a remote access point or station.

Additionally or alternatively, some exemplary embodiments of the invention may improve and/or maximize throughput, effective throughput, effective reception rate, effective engagement rate, reception quality, engagement quality, reception strength, engagement strength, and/or SNR of a WLAN cell, station, system, network and/or access point. For example, devices using exemplary embodiments of the invention may detect and/or restart engaging a stronger signal, instead of continuing to engage a weak signal, which may “break” and/or disappear.

Some embodiments of the invention may be implemented, for example, using a machine-readable medium or article which may store an instruction executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, e.g., memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors, or devices as are known in the art. Some embodiments of the invention may include buffers, registers, storage units and/or memory units, for temporary or long-term storage of data or in order to facilitate the operation of a specific embodiment.

While certain features of the invention have been illustrated and described herein, many modifications, substitutions, changes, and/or equivalents may occur to those skilled in the art. It is, therefore, to be understood that the appended claims are intended to cover all such modifications and/or changes.

1. A method comprising:
detecting during engagement of a first wireless communication signal a second wireless communication signal.

2. The method of claim 1, further comprising, upon detection of said second signal, selecting to engage either said first or second signals.

3. The method of claim 2, wherein selecting to engage comprises applying a criterion relating to a property of either or both said first and second signals.

4. The method of claim 2, wherein selecting to engage comprises comparing a property of the first signal to a corresponding property of the second signal.

5. The method of claim 2, wherein selecting to engage comprises comparing a property of the second signal to a threshold value.

6. The method of claim 2, wherein selecting to engage comprises:
continuing to engage the first signal if a pre-defined criterion is met; and
reverting to engage the second signal if the pre-defined criterion is not met.

7. The method of claim 2, comprising engaging the selected signal.

8. The method of claim 7, wherein engaging the selected signal comprises storing data in a buffer.

9. The method of claim 8, comprising resetting said buffer before storing data in said buffer.

10. The method of claim 1, wherein detecting the second signal comprises substantially continuously searching for the second signal.

11. An apparatus comprising:
a detector to detect during engagement of a first wireless communication signal a second wireless communication signal.

12. The apparatus of claim 11, comprising a processor to select, upon detection of said second signal, to engage either said first or second signals.

13. The apparatus of claim 12, wherein the processor is able to apply a criterion relating to a property of either or both said first and second signals.

14. The apparatus of claim 12, wherein the processor is able to compare a property of the first signal to a corresponding property of the second signal.

15. The apparatus of claim 12, wherein the processor is able to compare a property of the second signal to a threshold value.

16. The apparatus of claim 12, wherein the processor is able to continue to engage the first signal if a pre-defined criterion is met, and to revert to engage the second signal if the pre-defined criterion is not met.

17. The apparatus of claim 12, wherein the processor is able to engage the selected signal.

18. The apparatus of claim 17, comprising a buffer to store the selected signal.

19. The apparatus of claim 18, wherein the processor is able to reset said buffer.

20. The apparatus of claim 11, comprising a detector to substantially continuously search for the second signal.

21. A wireless communication device comprising:
a dipole antenna to send and receive wireless communication signals; and
a detector to detect during engagement of a first wireless communication signal a second wireless communication signal.

22. The wireless communication device of claim 21, wherein the wireless communication device comprises a wireless modem.

23. The wireless communication device of claim 21, comprising a processor to select, upon detection of said second signal, to engage either said first or second signals.

24. The wireless communication device of claim 21, comprising a detector to substantially continuously search for the second signal.

25. The wireless communication device of claim 21, comprising a processor to apply a criterion relating to a property of either or both said first and second signals.

26. The wireless communication device of claim 21, comprising a processor to continue to engage the first signal if a pre-defined criterion is met, and to revert to engage the second signal if the pre-defined criterion is not met.

27. The wireless communication device of claim 23, comprising a processor to engage the selected signal.

28. A wireless communication system comprising:
a first access point to transmit a first signal;
a second access point to transmit a second signal;
a wireless communication device to engage the first signal and, while engaging the first signal, detect the second signal.

29. The wireless communication system of claim 28, wherein the wireless communication device comprises a processor to select, upon detection of said second signal, to engage either said first or second signals.

30. The wireless communication system of claim 28, wherein the wireless communication device comprises a detector to substantially continuously search for the second signal.

31. The wireless communication system of claim 28, wherein the wireless communication device comprises a processor to engage the selected signal.

32. A machine-readable medium having stored thereon a set of instructions that, if executed by a machine, cause the machine to perform a method comprising detecting during engagement of a first wireless communication signal a second wireless communication signal.

33. The machine-readable medium of claim 32, wherein the instructions result in, upon detection of said second signal, selecting to engage either said first or second signals;

34. The machine-readable medium of claim 33, wherein the instructions that result in selecting to engage result in applying a criterion relating to a property of either or both said first and second signals.

35. The machine-readable medium of claim 33, wherein the instructions that result in selecting to engage result in comparing a property of the first signal to a corresponding property of the second signal.

36. The machine-readable medium of claim 33, wherein the instructions that result in selecting to engage result in comparing a property of the second signal to a threshold value.

37. The machine-readable medium of claim 33, wherein the instructions that result in selecting to engage result in:
continuing to engage the first signal if a pre-defined criterion is met; and
reverting to engage the second signal if the pre-defined criterion is not met.

38. The machine-readable medium of claim 31, wherein the instructions result in engaging the selected signal.

39. The machine-readable medium of claim 38, wherein the instructions that result in engaging the selected signal result in storing data in a buffer.

40. The machine-readable medium of claim 39, wherein the instructions result in resetting said buffer before storing data in said buffer.

41. The machine-readable medium of claim 31, wherein the instructions that result in detecting the second signal result in substantially continuously searching for the second signal.
